(19) United States
(12) Patent Application Publication
(10) Pub. No.: US 2018/0201184 A1
(43) Pub. Date: Jul. 19, 2018

(54) LIGHT EMITTING DEVICE FOR CAR BELT MOLDING

(71) Applicant: SIRIUSTEK INCORPORATED, Tainan City (TW)

(72) Inventors: JYH HUEI LAY, TAINAN CITY (TW); HUNG LUNG CHUANG, TAINAN CITY (TW)

(21) Appl. No.: 15/869,273

(22) Filed: Jan. 12, 2018

(30) Foreign Application Priority Data
Jan. 16, 2017 (TW) 106200761
Mar. 13, 2017 (CN) 201720238841.5

(51) Int. Cl. B60Q 1/50; B60Q 1/26; F21S 43/237; F21S 45/47; F21S 43/14

(52) U.S. Cl. CPC B60Q 1/50; B60Q 1/2669; F21S 43/237; F21Y 2115/10; F21S 43/14; B60Q 1/2696; F21S 45/47

(57) ABSTRACT

A light emitting device for a car belt molding includes the belt molding with a containing space having a long and narrow opening disposed between the outer door panel of a car door and the car window, a light emitting module is installed inside the containing space and linked to a controller, so that the controller can drive the light emitting module for continuous lighting with steady or blinking or different colors to notify the status of the motor vehicle, so as to achieve the effects of local lighting and decoration, or warning cars or pedestrians coming from behind.

### FIELD OF THE INVENTION

The present invention relates to a light emitting device, and especially for that used to surround the car windows and placed inside belt molding parts.

### BACKGROUND OF THE INVENTION

### 1. Description of the Related Art

The vehicle installs with a light emitting module, not just providing a decorative effect only, but also providing a warning effect for daytime and nighttime and improving the safety of driving. Statistics indicate that may accidents are caused by opening a car door without taking much care, so some governmental agencies aggressively promotes the policy of opening the car door by two stages. However, there are still many drivers or passengers not paying much attention to cars coming from behind, but often opening the car door directly and carelessly. As a result, the approaching cars fail to respond and accidents occur.

To improve the aforementioned problem, R.O.C. Pat. Publication No. M315676 discloses an “Automobile multifunctional car-opening LED warning light”, wherein an LED warning light is installed on a car door panel, so that a blinking warning light signal will be issued when a car receives a signal indicating a car sending out a signal light and a passenger opens the car door, and a steady light signal will be issued when a headlight-on signal is received, so as to achieve the reminding effect.

R.O.C. Pat. Publication No. M473959 discloses a “Safety device for car door opening automatic enhanced lighting and warning, wherein a warning fixing strip is installed at an edge of a car door frame of a car body, and a sensing switch is installed at the car body, so that when the sensing switch determines that the car door is opened, a light emitting element emits light to achieve both lighting and warning effects.

R.O.C. Pat. Publication No. M504034 has disclosed an “Automobile door-opening external warning device”, wherein a light source module is installed at a car door of a motor vehicle, and a control switch is installed at a handle inside the car door, so that when the handle is operated, the control switch is linked to transmit a signal to a light source control module, so that a power supply and a light source module form a current path to emit light, so as to achieve a warning effect.

R.O.C. Pat. Publication No. M504026 has disclosed an “Automobile door-opening warning device”, wherein an internal light source module and a buzzer are installed on an inner side of a car door of a motor vehicle, and an external light source module is installed on an outer side of the car door and an outer portion is disposed on the outer side of the car door, and the motor vehicle has a sensing module and a control module installed therein, so that when the motor vehicle is parked and the sensing module has sensed an external coming car or a pedestrian, the control module will drive the internal and external light source modules and the buzzer to remind the people in the car and the pedestrians or cars outside the car, so as to achieve a warning effect.

In the aforementioned patents, the light emitting device is installed on the inner side or outer side of the car door to achieve the warning effect. However, when the light emitting device is installed on the inner side of the car door, the reminding effect can be provided only after the car door is opened, so that the warning effect is not good enough. When the light emitting device is installed on the outer side of the car door, the aesthetic appearance of the car will be ruined. Therefore, the drivers are generally not willing to install such light emitting device.

In addition, U.S. Pat. No. 8,506,143 has disclosed a “Molded part for motor vehicles”, wherein a strip-shaped molded part of the motor vehicle has a plurality of small light transmitting holes, and a plurality of light transmitting plates installed sequentially on the strip-shaped molded part facing the light transmitting holes respectively, and a light transmitting surface is formed at a light emitting diode and an end cap, or the strip-shaped molded part, and an organic electro-luminescence (OEL) plate and an end cap are disposed on the light transmitting surface, so that the light emitting diode or the OEL plate can emit a light source and provide a direction instruction through the light transmitting holes or light transmitting plate according to the automatic operation of the car door and the release of a car lock.

### 2. Summary of the Invention

In view of the drawbacks of the conventional light emitting device that installs a light emitting module on the inner side or outer side of the car door and has the drawbacks of a poor warning effect and a bad appearance, the present invention provides a novel light emitting device to overcome the drawbacks of the prior art.

Therefore, it is a primary object of the present invention to install a light emitting module without affecting the original appearance of the motor vehicle.

Another objective of the present invention is to sense an action of a car such as a brake, a parking, or a door opening of a car door to issue a signal by a remote control of the motor vehicle in order to drive a light emitting module to emit a light source from an outer side of the motor vehicle, so as to achieve a warning effect.

To achieve the aforementioned and other objectives, the present invention provides a light emitting device for a car belt molding, and the light emitting device is installed in the motor vehicle and comprises: a belt molding, installed between the outer door panel of a car door of the motor vehicle and the car window, and having containing space with a long and narrow opening; a light emitting module, installed in the containing space, and capable of emitting a light source from the long and narrow opening; and a controller, electrically linked to the light emitting module, for driving the light emitting module to emit the light source after receiving a signal of the motor vehicle.

According to the description above, a signal is sent to the controller when a driver presses a brake or stops the car and uses a remote control of the motor vehicle to detect if a driver or a passenger has a hand approaching or turning a car door handle of the motor vehicle. After the controller has received the signal of the aforementioned action, the controller drives the light emitting module installed in the belt molding to emit a light source with steady or blinking or different colors, so as to achieve the local lighting, decoration or warning effects.

### BRIEF DESCRIPTION OF THE DRAWINGS

FIG. 1 is a perspective view showing the structure of the present invention;

FIG. 2 is a schematic view of assembling a light emitting device of a first embodiment of the present invention;

FIG. 3 is a sectional view of assembling a light emitting device of the first embodiment of the present invention;

FIGS. 4˜7 for schematic views of using a light emitting device of the first embodiment of the present invention;

FIG. 8 is a schematic view of assembling a light emitting device of a second embodiment of the present invention;

FIG. 9 is a cross-sectional view of assembling a light emitting device of the second embodiment of the present invention.

### DESCRIPTION OF THE PREFERRED EMBODIMENTS

The above and other objects, features and advantages of this disclosure will become apparent from the following detailed description taken with the accompanying drawings.

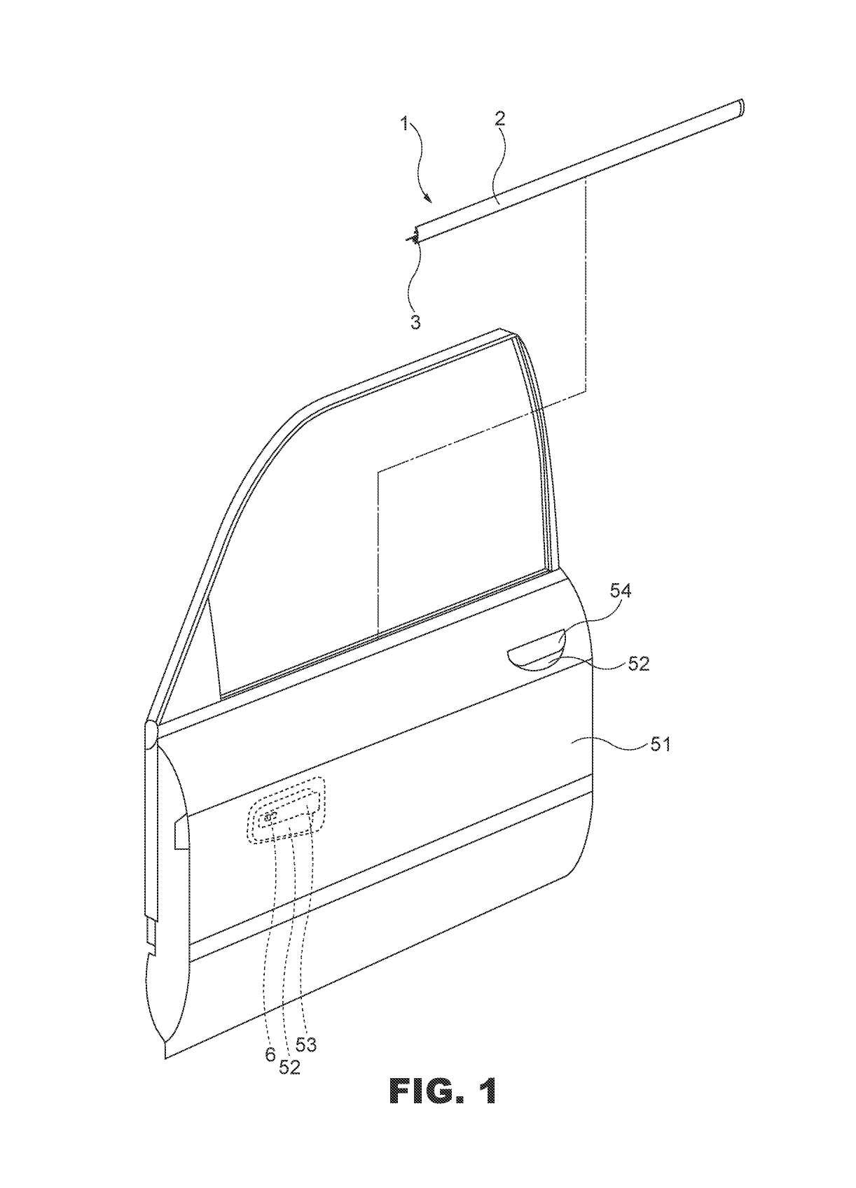

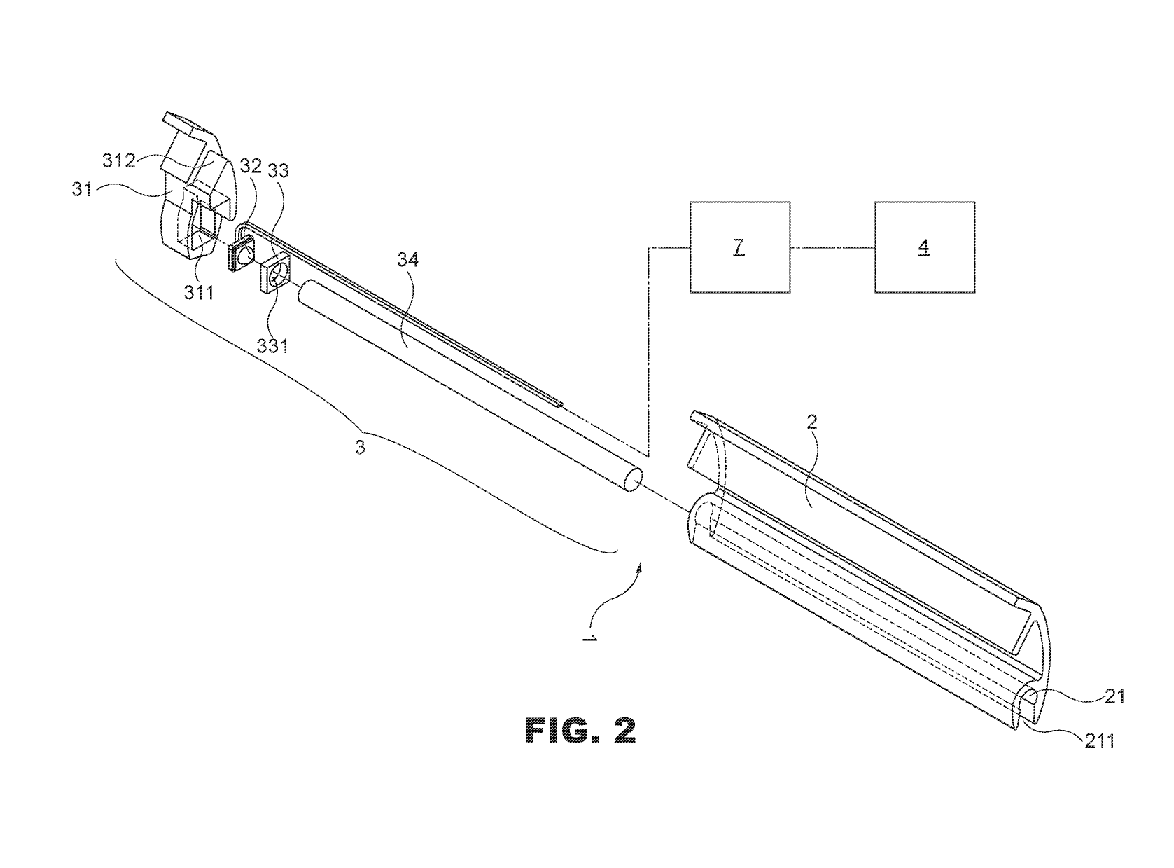

With reference to FIGS. 1-3 for a light emitting device 1 of the present invention, the light emitting device 1 is installed in a motor vehicle 5 (not shown in the figure) and comprises a belt molding 2, a light emitting module 3, a regulator 7 and a controller 4. The belt molding 2 is an external belt molding installed between the outer door panel of a car door 51 and the car window 55. A containing space 21 with a long and narrow opening 211 is formed in the belt molding 2. The light emitting module 3 is installed in the containing space 21. Preferably, the containing space 21 is arc shape cross-section, and the light source can be emitted from the long and narrow opening 211. In the first embodiment of the present invention, the light emitting module 3 comprises an end cap 31, a point light source 32, a sleeve 33 and a light guide rod 34, wherein the end cap 31 is made of a material with a heat dissipation effect, preferably aluminum, or ceramic, and the end cap 31 has a containing groove 311 and a protruding member 312, and the end cap 31 may be embedded or engaged with an edge of the belt molding 2 by the protruding member 312, and the point light source 32 is arranged in the containing groove 311 of the end cap 31. Preferably, the point light source 32 is a LED or laser; and the sleeve 33 is also installed into the containing groove 311 of the end cap 31, and has a through hole 331 formed thereon, and the light guide rod 34 is installed in the arc shape cross-section containing space 21 of the belt molding 2 and passed through the through hole 331 of the sleeve 33 and attached to the point light source 32. Preferably, the light guide rod 34 is made of a hard material or a bendable/flexible optical fiber, so that the light energy of the point light source 32 can be emitted uniformly by the light guide rod 34, and the light energy of the light emitting module 3 is a continuous light source, a blinking light source, a white light source, a monochromic or three primary colors (RGB) mixed light source. The regulator 7 is electrically linked to the light emitting module 3 and the controller 4. After the controller 4 has received a signal of the motor vehicle 5 (not shown in the figure), the controller 4 drives the light emitting module 3 to emit the light source.

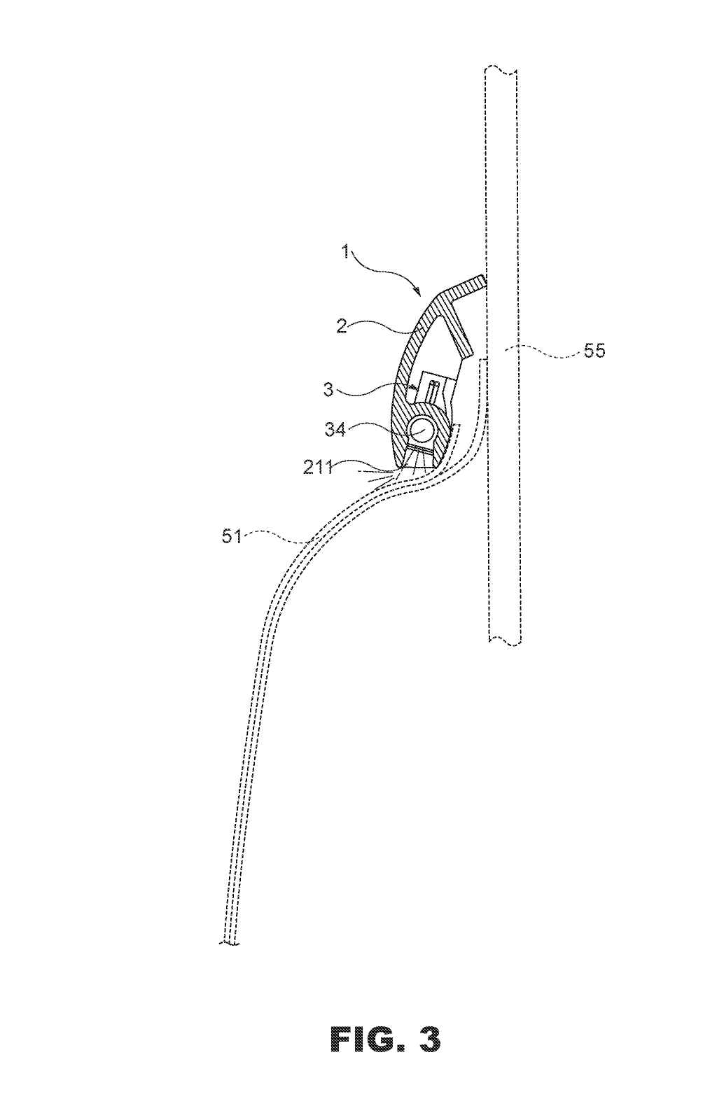

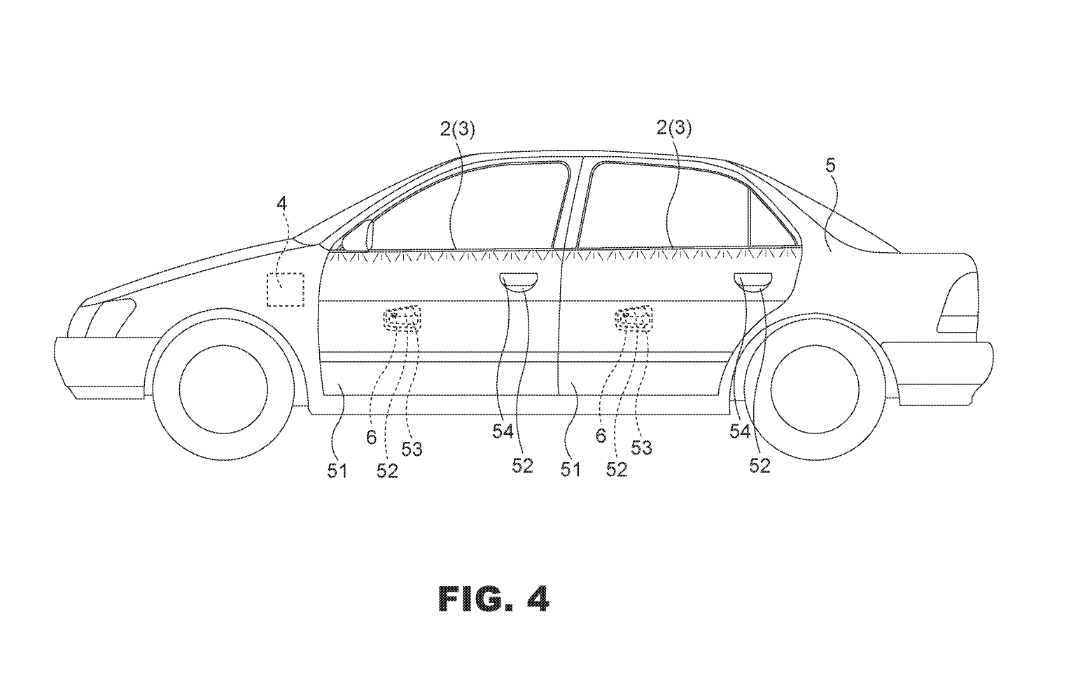

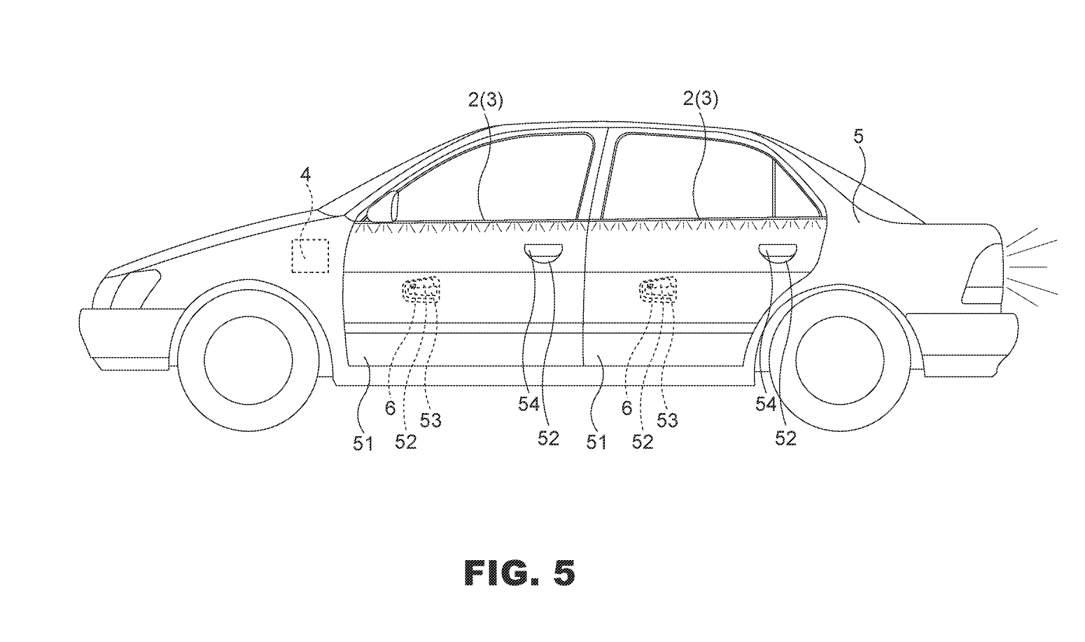

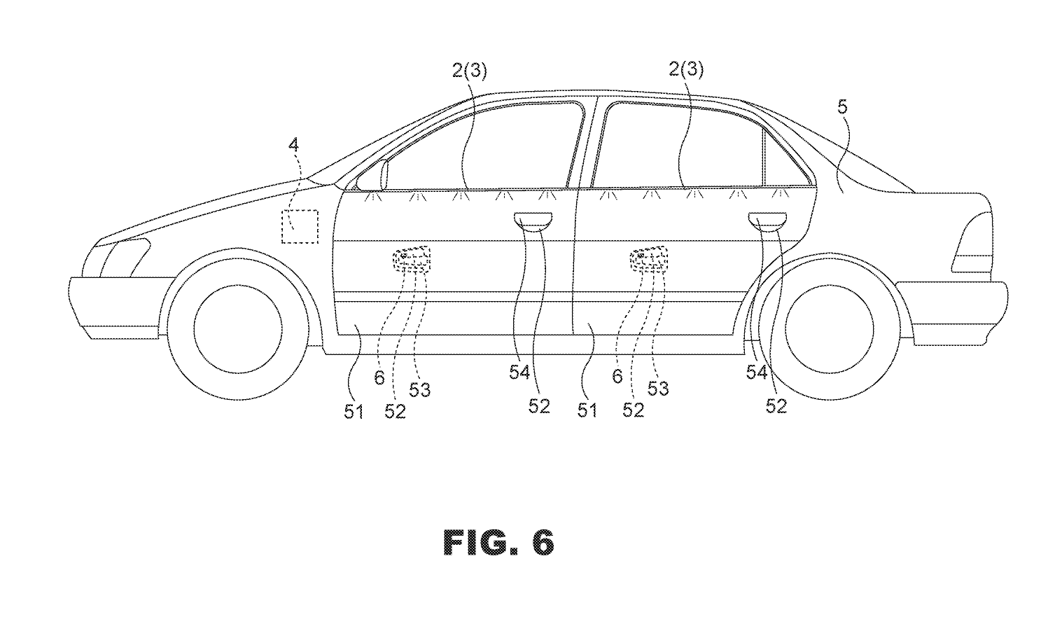

In an embodiment of the present invention as shown in FIGS. 3 and 4, after the external belt molding 2 of the motor vehicle 5 is combined with the light emitting module 3, if a driver or a passenger has turned an internal car door handle 53 or an external car door handle 54 of the motor vehicle, a signal of the external car door handle 53 (54) will be sent to the controller 4. After the controller 4 has received the signal, the controller drives the light emitting module 3 to emit the light source from the long and narrow opening 211 of the belt molding 2, and pass the light source to the outside from a position between the belt molding 2 and a lower edge of a casing of the car door 51 so as to remind any car coming from behind or a pedestrian when the car door 51 of the motor vehicle 5 is about to be opened.

In another embodiment of the present invention as shown in FIG. 5, after the external belt molding 2 of the motor vehicle 5 is combined with the light emitting module 3, if the motor vehicle 5 is braked or parked or the remote control of the motor vehicle 5 is used, then the brake, park, or remote control signal will be sent to the controller 4, so that after the controller 4 has received the signal, the controller 4 drives the light emitting module 3 to emit a continuous light source. If a driver or a passenger turns an internal car door handle 53 of the motor vehicle, the signal of turning the internal or external car door handle 53 (54) will be sent to the controller 4. After the controller 4 has received the signal, the controller 4 drives the light emitting module 3 to emit a blinking light source (as shown in FIG. 6), so as to remind the cars coming from behind or pedestrians by different modes of the light source about the status of the motor vehicle 5 (during braking, parking or opening the car door).

In a further embodiment of the present invention, the light emitting device 1 further comprises a sensor 6 installed in a containing groove 52 for containing the internal and external car door handles 53 (54) and provided for generating a signal and transmitting the signal to the controller 4 when a human hand extends into or approaches to the internal car door handle 53 or the external car door handle 54. If the motor vehicle 5 is braked or parked (as shown in FIG. 5) or a remote control of the motor vehicle 5 is used, then the brake, parking or remote control signal will be transmitted to the controller 4. After the controller 4 has received the signal, the controller 4 will drive the light emitting module 3 to emit a continuous light source. When a driver or a passenger extends a hand into the containing groove 52 or approaches the internal car door handle 53 or the external car door handle 54, the sensor 6 will send the sensed signal to the controller 4. After the controller 4 has received the signal, the controller 4 will drive the light emitting module 3 to emit a blinking light source (as shown in FIG. 6).

In addition, the light emitting module 3 is a white light source, a monochromic light source, or a three primary colors (RGB) mixed light source and may be installed in the containing space 21 of all belt molding 2 of the motor vehicle 5 (as shown in FIG. 7), so that the controller 4 can drive the light emitting module 3 to emit a light source of different colors according to a signal indicating that the motor vehicle 5 is braked or parked, or a remote control is used, or a driver or a passenger turns or approaches the internal or external car door handle 53 (54) of the motor vehicle, so as to achieve the reminding and warning effects by the light source of different colors.

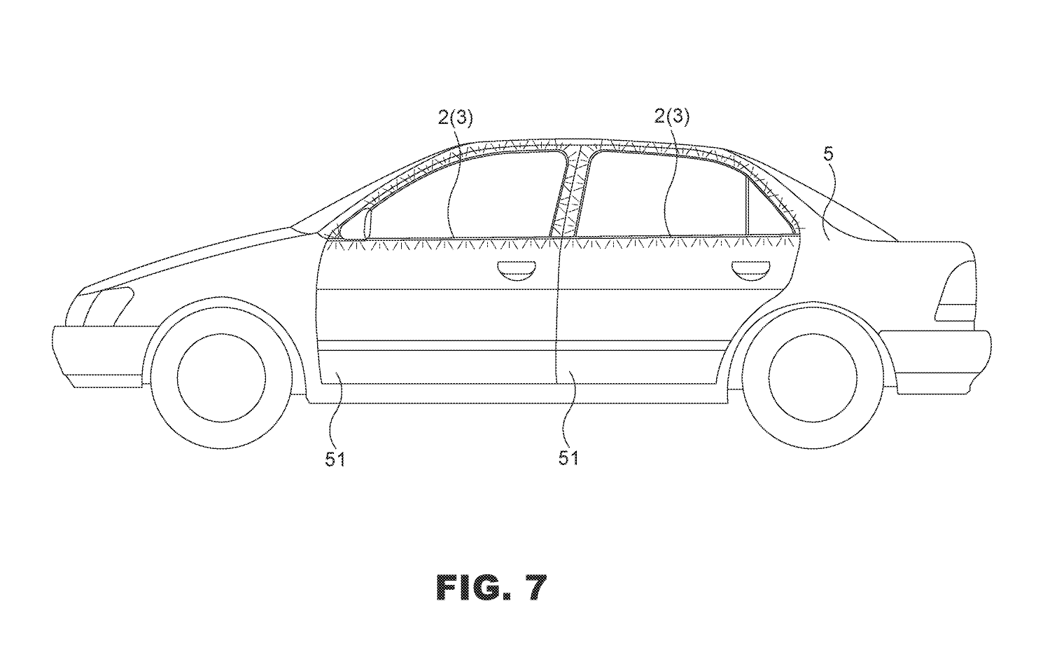

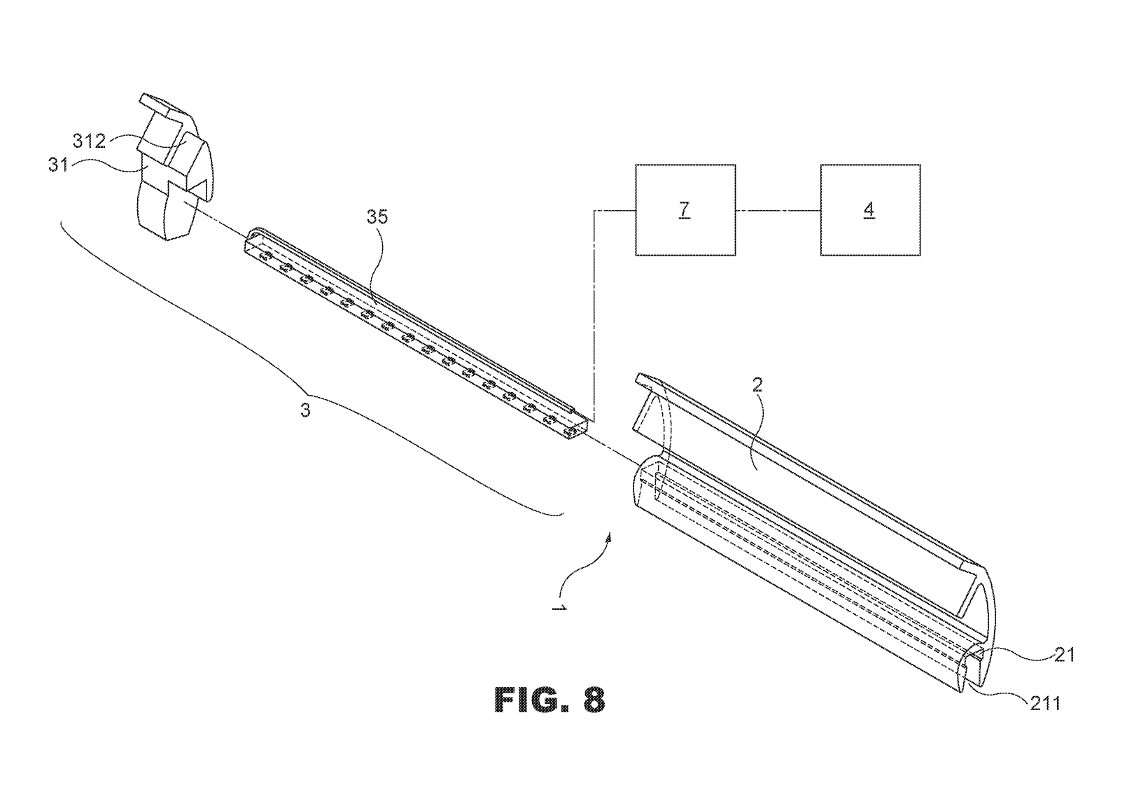

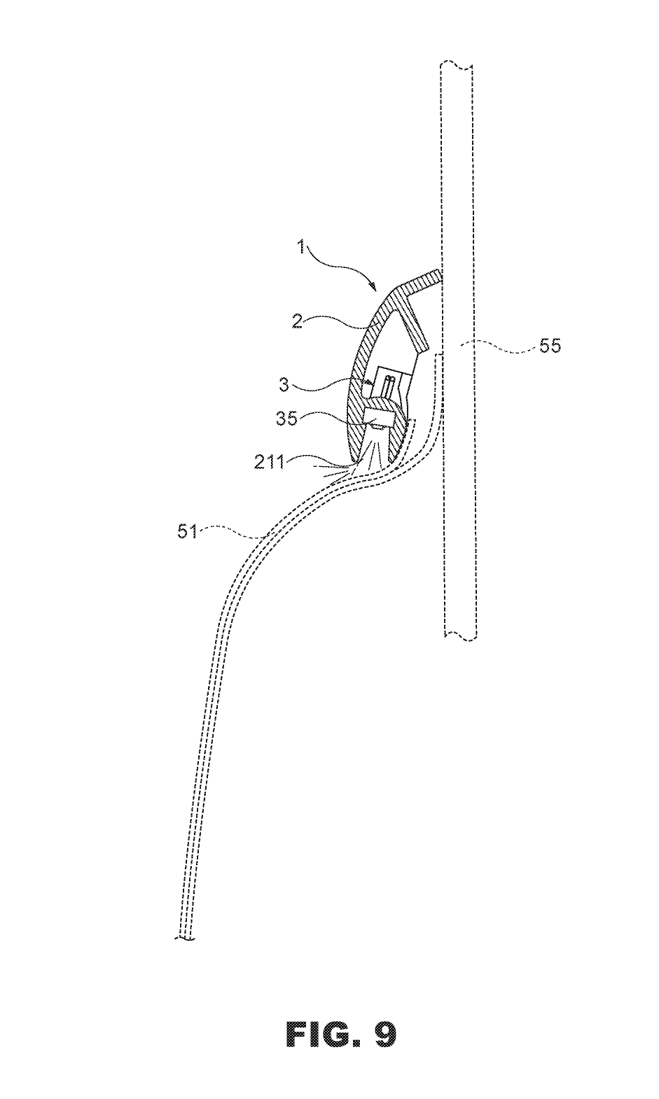

With reference to FIGS. 8-9 for the second embodiment of the present invention, the light emitting module 3 comprises an end cap 31 and a LED strip 35, wherein the end cap 31 has a protruding member 312, and the end cap 31 can be embedded or engaged with the belt molding 2 by the protruding member 312. Preferably, the containing space 21 of the belt molding 2 is in a square shape cross-section and provided for installing the LED strip 35, so that the LED strip 35 can emit the light source from the long and narrow opening 211 of the belt molding 2.

In summation, the light emitting device for a car belt molding in accordance with the present invention has the following advantages and effects:

1. In the present invention, the light emitting module is combined with the belt molding between the car door of the motor vehicle car door and a piece of an outer car window glass, so that halos may be transmitted from a position between the belt molding and a lower edge of the outer door panel of the car door without changing the appearance of the motor vehicle to prevent the light source from being too dazzling, violating any related laws and regulations, or ruining the aesthetic appearance of the motor vehicle. As a result, the car is more streamlined and gains a good decorative effect, and people can see the light without seeing the lamp.

2. In the present invention, the light emitting module is combined with the belt molding between the car door of the motor vehicle and a piece of the external car window glass, so that the circuit of the light emitting module can be electrically connected to the external regulator through the gap of the belt molding, so as to prevent the regulator from occupying the internal space of the belt molding.

3. In the present invention, if a signal indicating that the motor vehicle is braked or parked, or a human hand extends into the car door, or the car door is about to be opened from the containing groove of the internal or external car door handle is sensed, the light emitting module will be driven to emit a light source, or the original component of the motor vehicle (such as a signal light) may be combined to achieve the effect of preventing the car from making a turn in a dead end or reminding or warning the cars coming from behind and the pedestrians.

4. The light emitting module of the present invention has a continuous light source, a blinking light source, or a light source of different colors, so as to provide a warning effect according to the different modes of the light source when the motor vehicle is braked or parked or the car door is about to be opened.

5. In the present invention, a single LED or laser is combined with the light guide rod made of a hard material or a bendable/flexible optical fiber or a LED strip, so that the invention is applicable for a nonlinear or cured car window frame, and capable of reducing the consumption of the LEDs, the material cost, the power consumption, and the and failure rate, as well as improve the light output efficiency.

6. In the present invention, the controller can drive the light emitting device to emit the light source after a signal indicating that the remote control is used, or a human hand extends into the containing groove of the external car door handle of the car door is received, so as to achieve a local lighting effect of the light source.

7. In the present invention, the light emitting module is integrated with the belt molding, and a whole-piece design is adopted to improve the convenience of installation. The invention can overcome the issue of turning off the light during the installation of the light guide rod.

What is claimed is:

1. A light emitting device for a car belt molding, installed in a motor vehicle, comprising:
a belt molding, installed between the outer door panel of a car door and the car window, and having containing space with a long and narrow opening;
a light emitting module, installed inside the containing space, and capable of emitting a light source from the long and narrow opening; and
a controller, electrically linked to the light emitting module, for driving the light emitting module to emit the light source after receiving a signal of the motor vehicle.

2. The light emitting device for a car belt molding according to claim 1, wherein the light emitting module comprises an end cap installed at an edge of the belt molding, a containing groove formed at the end cap, a point light source contained in the containing groove, a sleeve having a through hole, and a light guide rod passing through the through hole, so that the light guide rod is attached to the point light source, and the light source can be emitted from the long and narrow opening of the belt molding.

3. The light emitting device for a car belt molding according to claim 2, wherein the end cap has a protruding member and is capable of embedding the corresponding belt molding by the protruding member.

4. The light emitting device for a car belt molding according to claim 2, wherein the end cap is made of a material with a heat dissipation effect.

5. The light emitting device for a car belt molding according to claim 2, wherein the point light source is a LED or laser.

6. The light emitting device for a car belt molding according to claim 2, wherein the light guide rod is made of a hard material or a bendable/flexible optical fiber.

7. The light emitting device for a car belt molding according to claim 2, wherein the containing space is arc shape cross-section.

8. The light emitting device for a car belt molding according to claim 1, wherein the light emitting module comprises an end cap installed at an edge of the belt molding, and a LED strip installed in the containing space of the belt molding, so that the light source can be emitted from the long and narrow opening of the belt molding.

9. The light emitting device for a car belt molding according to claim 8, wherein the end cap has a protruding member, and the end cap is embedded and engaged with the belt molding by the protruding member.

10. The light emitting device for a car belt molding according to claim 8, wherein the containing space is in a square shape cross-section.

11. The light emitting device for a car belt molding according to claim 1, wherein the containing groove provided for containing the car door handle further comprises a sensor for generating a signal when any part of a human body extends into the containing groove and sending the signal to the controller, so that the controller drives the light emitting module to emit the light source after receiving the signal from the sensor.

12. The light emitting device for a car belt molding according to claim 1, wherein the signal of the motor vehicle is one selected from the group consisting of a brake signal, a parking signal, a car door handle turning signal, and a car remote control signal.

13. The light emitting device for a car belt molding according to claim 1, further comprising a regulator installed between the controller and the light emitting module.

14. The light emitting device for a car belt molding according to claim 1, wherein the belt molding is an external belt molding installed between the outer door panel of a car door and an external car window.

15. The light emitting device for a car belt molding according to claim 1, wherein the light source is a continuous light source, a blinking light source, a white light source, a monochromic light source, or a three primary colors (RGB) mixed light source.
